(19) United States
(12) Patent Application Publication
(10) Pub. No.: US 2006/0247123 A1
(43) Pub. Date: Nov. 2, 2006

(54) Method for making partially dried readily dispersible olefin polymerization procatalyst

(76) Inventors: Gina R. Shaub, Katy, TX (US); Peter A. Kilty, Sugar Land, TX (US)

Correspondence Address: THE DOW CHEMICAL COMPANY, INTELLECTUAL PROPERTY SECTION,, P. O. BOX 1967, MIDLAND, MI, 48641-1967, US

(21) Appl. No.: 10/565,479

(22) PCT Filed: Jul. 30, 2004
(86) PCT No.: PCT/US04/24949

§ 371 Date: Jan. 20, 2006

Related U.S. Application Data
(60) Provisional application No. 60/499,119, filed on Aug. 29, 2003.

(51) Int. Cl. B01J 31/00

(52) U.S. Cl. 502/103; 502/118; 502/125; 502/104; 502/108

(57) ABSTRACT

A method of making a hydrocarbon oil dispersion of a solid procatalyst for use in a Ziegler-Natta olefin polymerization catalyst composition, said method comprising: preparing and recovering a procatalyst composition in the form of a solid mass containing residual liquid rinse diluant, partially drying the solid procatalyst composition to provide a residual liquid rinse diluent content of from 7 to 25 percent, and dispersing the partially dried, solid precursor composition in a hydrocarbon oil.

### CROSS REFERENCE STATEMENT

This application claims the benefit of U.S. Provisional Application No. 60/499,119, filed Aug. 29, 2003.

### BACKGROUND OF THE INVENTION

The present invention relates to improved stereoselective polymerization catalyst compositions of the Ziegler-Natta type, procatalysts for use in forming such catalyst compositions, methods of making such catalyst compositions and procatalysts, and to methods of using the catalyst compositions to make an olefin polymer.

Stereoselective Ziegler-Natta olefin polymerization catalyst compositions typically comprise a solid component containing magnesium, titanium and halide moieties in combination with an internal electron donor (which combination is referred to as the “procatalyst”), a substance that is capable of converting the procatalyst to an active polymerization catalyst (referred to as a “cocatalyst”), and a selectivity control agent (SCA) or external electron donor. Suitable internal electron donors especially include alkylesters of aromatic mono- or dicarboxylic acids, such as alkylbenzoates, dialkylphthalates, and mono- and di- C₁₋₄ alkylether derivatives thereof, such as p-ethoxyethylbenzoate. Conventional cocatalysts include aluminum trialkyls, such as triethylaluminum or triisobutylaluminum. The cocatalyst may be combined or complexed with some or all of the internal electron donor, selectivity control agent, or both, if desired. Examples of suitable selectivity control agents include silanes, siloxanes, the previously noted alkylesters of aromatic mono- or dicarboxylic acids, and mixtures thereof.

Various methods of preparing procatalysts are previously disclosed in the patent art. Examples include: U.S. Pat. No. 5,247,032, 5,247,031, 5,229,342, 5,153,158, 5,151,399, 5,146,028, 5,124,298, 5,106,806, 5,082,907, 5,077,357, 5,066,738, 5,066,737, 5,034,361, 5,028,671, 4,990,479, 4,927,797, 4,829,037, 4,816,433, 4,728,705, 4,548,915, 4,547,476, 4,540,679, 4,535,068, 4,472,521, 4,460,701, 4,442,276, and 4,330,649. One preferred method from among the foregoing disclosures is a method of forming a “procatalyst precursor” from a mixture of magnesium dialkoxides and titanium alkoxides and reacting the mixture with titanium tetrachloride in the presence of an alcohol, an aromatic hydroxide compound, and an aromatic solvent, especially chlorobenzene. In this manner, a solid material is recovered by selective precipitation upon removal of alcohol from the solution. This precursor is thereafter contacted with an internal electron donor and halogenated by contacting with TiCl₄ or similar halogenating agent in a hydrocarbon or halohydrocarbon solvent. The halogenation may be repeated one or more times until a procatalyst of the desired form is prepared. The resulting product may be further treated, if desired, with additional agents such as an acid chloride, especially benzoyl chloride or phthaloyl chloride, or other additives. The resulting product is then extracted or rinsed one or more times to remove byproducts and residual halogenating agent, filtered to separate the solid procatalyst, and dried to remove volatile components. Typically, the product is dried by contacting with a heated nitrogen stream until less than 5 percent residual hydrocarbon remains. The solid, friable mass is then redispersed in a hydrocarbon oil for ease of transport and metering in a polymerization process.

Although the foregoing process produces a product having desirable properties, the resulting procatalyst dispersion often includes an inordinate number of oversized dispersed particles, which can lead to inferior polymer particle production in a polymerization process. It would be desirable if there were provided a method of producing a hydrocarbon oil dispersion of a procatalyst in which the number of unacceptable large particles in said dispersion is reduced or minimized.

### SUMMARY OF THE INVENTION

According to the present invention, there is provided a method of making a hydrocarbon oil dispersion of a solid procatalyst composition for use in a Ziegler-Natta olefin polymerization catalyst composition, said method comprising:

contacting a solid precursor composition comprising magnesium, titanium, and alkoxide moieties with a halogenating agent and an internal electron donor in any order, in a suitable reaction medium to prepare a solid procatalyst composition by halogen exchange;

separating the solid procatalyst composition from the reaction medium;

optionally further halogenating the solid procatalyst composition, exchanging the procatalyst composition under metathesis conditions, substituting metal values in the procatalyst composition, and/or extracting the procatalyst composition;

rinsing the procatalyst composition with liquid rinse diluent to remove at least a portion of by-products and/or unreacted halogenating agent;

separating the procatalyst composition from the liquid rinse diluent to provide a solid mass containing residual liquid rinse diluent;

partially drying the solid procatalyst composition to provide a mass having a residual liquid rinse diluent content of from 7 to 25 percent; and

dispersing the partially dried, solid precursor composition in a hydrocarbon oil.

Also included in the present invention are the dispersions of solid procatalysts resulting from the foregoing methods of preparation and an improved olefin polymerization process comprising contacting an olefm monomer under olefm polymerization conditions in the presence of the foregoing procatalyst dispersion and a cocatalyst.

Procatalyst dispersions of the present invention prepared from solid procatalyst compositions containing from 7 to 25 percent liquid diluent are used in preparing α-olefin polymers, especially propylene based polymers, such as polypropylene or ethylene/propylene copolymers having improved uniformity. The compositions are more readily dispersed in hydrocarbon oils than are procatalysts that are more thoroughly dried and result in the formation of dispersions containing fewer, undesirable, large particles.

### DETAILED DESCRIPTION

All reference to the Periodic Table of the Elements herein shall refer to the Periodic Table of the Elements, published and copyrighted by CRC Press, Inc., 2001. Also, any reference to a Group or Groups shall be to the Group or Groups as reflected in this Periodic Table of the Elements using the IUPAC system for numbering groups. For purposes of United States patent practice, the contents of any patent, patent application or publication referenced herein are hereby incorporated by reference in their entirety herein, especially with respect to the disclosure of structures, synthetic techniques and general knowledge in the art. The term “aromatic” or “aryl” refers to a polyatomic, cyclic, ring system containing (4δ+2) π-electrons, wherein δ is an integer greater than or equal to 1.

If appearing herein, the term “comprising” and derivatives thereof is not intended to exclude the presence of any additional component, step or procedure, whether or not the same is disclosed herein. In order to avoid any doubt, all compositions claimed herein through use of the term “comprising” may include any additional additive, adjuvant, or compound, unless stated to the contrary. In contrast, the term, “consisting essentially of” if appearing herein, excludes from the scope of any succeeding recitation any other component, step or procedure, excepting those that are not essential to operability. The term “consisting of”, if used, excludes any component, step or procedure not specifically delineated or listed. The term “or”, unless stated otherwise or clear from the context, refers to the listed members individually as well as in any combination.

The term “hydrocarbon oil” interchangeably referred to as “mineral oil” refers to petroleum fractions with a distillation point of at least 370° C., preferably aliphatic hydrocarbon products that are relatively free of wax.

As mentioned above, the olefin polymerization procatalyst precursors employed in the invention comprise magnesium moieties. Sources for such magnesium moieties include anhydrous magnesium dichloride, magnesium dialkoxides or aryloxides, or carboxylated magnesium dialkoxides or aryloxides. Preferred sources of magnesium moieties are magnesium di-(C₁₋₄)alkoxides, especially diethoxymagnesium. Additionally, the precursors comprise titanium moieties. Suitable sources of titanium moieties include titanium alkoxides, titanium aryloxides, and titanium halides. Preferred precursors comprise one or more magnesium di-(C₁₋₄)-alkoxides and one or more titanium tetra-(C₁₋₄)-alkoxides.

Various methods of making procatalyst precursor compounds are known in the art. These methods are described, inter alia, in U.S. Pat. Nos. 5,034,361; 5,082,907; 5,151,399; 5,229,342; 5,106,806; 5,146,028; 5,066,737; 5,077,357; 4,442,276; 4,540,679; 4,547,476; 4,460,701; 4,816,433; 4,829,037; 4,927,797; 4,990,479; 5,066,738; 5,028,671; 5,153,158; 5,247,031; 5,247,032, and elsewhere. In a preferred method, the preparation involves chlorination of the foregoing mixed magnesium and titanium alkoxides, and may involve the use of one or more compounds, referred to as “clipping agents”, that aid in forming specific compositions by means of a solid-solid methasis. Examples of suitable clipping agents include trialkylborates, especially triethylborate, phenolic compounds, especially cresol, and silanes.

A preferred procatalyst precursor for use herein is a mixed magnesium/titanium compound of the formula Mg_{d}Ti(OR^{e})ₑX_{f} wherein R^{e}, independently each occurrence, is an aliphatic or aromatic hydrocarbon radical having 1 to 14 carbon atoms or COR′ wherein R′ is an aliphatic or aromatic hydrocarbon radical having 1 to 14 carbon atoms; X is independently each occurrence, chlorine, bromine or iodine; d is 0.5 to 5, preferably 2-4, most preferably 3; e is 2-12, preferably 6-10, most preferably 8; and f is 1-10, preferably 1-3, most preferably 2. The precursors are ideally prepared by controlled precipitation through removal of an alcohol from the reaction mixture used in their preparation. An especially desirable reaction medium comprises a mixture of an aromatic liquid, especially a chlorinated aromatic compound, most especially chlorobenzene, an alkanol, especially ethanol, and a halogen source. Suitable halogen sources include inorganic halogen compounds, especially chlorine derivatives of silicon, aluminum or titanium, preferably titanium tetrachloride. Removal of the alkanol from the solution results in precipitation of the solid precursor, having especially desirable morphology and surface area. Moreover, the resulting precursors are particularly uniformly sized and resistant to particle crumbling as well as degradation of the resulting procatalyst.

The precursor is converted to a solid procatalyst by halogenation with a halogenating agent, preferably a titanium halide compound, and incorporation of an internal electron donor. If not already incorporated into the precursor in sufficient quantity, the electron donor may be added separately before, during or after halogenation.

Halogenation refers to a process by which the procatalyst precursor is modified by exchange of halide ligands for alkoxide groups thereby forming magnesium halide salts by means of a metathesis or exchange reaction. Suitable halogenation agents are those compounds that are capable of removing titanium species from the solid procatalyst precursor or adjusting the type or quantity of titanium species in the resulting composition without detrimentally affecting the resulting catalyst properties. It is preferred that the halogenating agent be soluble in the medium that contains the procatalyst or the precursor components. The halogenating agent may be complexed with another compound if desired.

Suitable halogenating agents for use herein include: TiCl₄, ZrCl₄, VCl₄, WCl₆, VOCl₃, SnCl₄, SiCl₄ and mixtures thereof. Suitable complexes include complexes of the foregoing compounds with appropriate ligands, preferably Lewis bases, especially electron donors such as diisobutyl phthalate (DIBP). Examples include ZrCl₄(DIBP) and VCl₄(DIBP). A preferred halogenation agent is TiCl₄. If a complex of a metal salt is employed, it is desirable that some quantity of free TiCl₄ also is included in the reaction mixture.

Suitable electron donors for use in the present invention are compounds that are free from active hydrogens that have been conventionally employed in the formation of titanium-based procatalysts. Particularly preferred electron donors include ethers, esters, amines, imines, nitriles, phosphines, stibines, and arsines. The more preferred electron donors, however are carboxylic acid esters or ether derivatives thereof, particularly C₁₋₄ alkyl esters of aromatic monocarboxylic or dicarboxylic acids and C₁₋₄ alkyl ether derivatives thereof. Examples of such electron donors are methylbenzoate, ethylbenzoate, isopropylbenzoate, isobutylbenzoate, ethyl p-ethoxybenzoate, ethyl p-methoxybenzoate, isopropyl p-ethoxybenzoate, isobutyl p-ethoxybenzoate, diethylphthalate, dimethylnaphthalenedicarboxylate, diisopropylphthalate, di-n-butylphthalate, and diisobutylphthalate. The electron donor can be a single compound or a mixture of compounds, but preferably the electron donor is a single compound. Particularly preferred internal electron donors are: ethylbenzoate, ethyl p-ethoxybenzoate, di-n-butylphthalate, and diisobutylphthalate.

In one embodiment of the invention, the electron donor may be formed in situ by contacting the procatalyst precursor with an organic halogenating agent, especially benzoyl chloride or phthaloyl dichloride, simultaneously with or after the foregoing procatalyst forming step. Sufficient electron donor usually is provided or prepared in situ, so that the molar ratio of electron donor to the magnesium present in the solid procatalyst at this stage of the preparation is from 0.01:1 to 3:1, preferably from 0.05:1 to 2:1.

An optional diluent may be employed in the production of the procatalyst compound. Examples include aliphatic or aromatic hydrocarbon or halohydrocarbon compounds containing up to 12 carbon atoms, more preferably up to 9 carbon atoms. Exemplary aliphatic hydrocarbons include pentane, hexane, octane, and mixtures of C₆₋₁₀ alkanes. Exemplary aromatic hydrocarbons include benzene, toluene, xylene, and ethylbenzene. Exemplary aliphatic halohydrocarbons include methylene chloride, methylene bromide, chloroform, carbon tetrachloride, 1,2-dibromoethane, 1,1,2-trichloroethane, dichlorofluoromethane and tetrachlorooctane. Exemplary aromatic halohydrocarbons include chlorobenzene, bromobenzene, dichlorobenzenes and chlorotoluenes. Of the aliphatic halohydrocarbons, compounds containing at least two chloride substituents are preferred, with carbon tetrachloride and 1,1,2-trichloroethane being most preferred. Of the aromatic halohydrocarbons, chlorobenzene or p-chlorotoluene are particularly preferred.

The manner in which the procatalyst precursor, the electron donor, halogenating agent, and optional diluent are contacted may be varied within wide limits. In one embodiment, the halogenating agent is added to a mixture of the electron donor and procatalyst precursor. More preferably however, the procatalyst precursor first is mixed with the halogenating agent and a halohydrocarbon, and the electron donor is added last, after a period lasting from 1 to 30 minutes of precontact between the precursor and halogenating agent. Ideally, the contact time and temperature are controlled in order to obtain a solid product having a desired particle morphology. Preferred contacting times of the precursor with the remaining ingredients in the procatalyst forming process are at least 10, preferably at least 15 and more preferably at least 20 minutes, up to 1 hour, preferably up to 45 minutes, most preferably up to 35 minutes, at a temperature from at least 25° C., preferably at least 50° C., most preferably at least 60° C., to a temperature up to 130° C., preferably up to 120° C., most preferably up to 115° C. At combinations of higher temperatures or longer contacting times, particle morphology, especially particle size, size distribution and porosity of the resulting procatalyst composition and the catalyst compositions formed therefrom, is adversely affected.

A preferred procatalyst for use herein is a mixed magnesium/titanium compound of the formula: Mg_{d′}Ti(OR^{e})_{e′}X_{f}(ED)_{g′}wherein R^{e}, independently each occurrence, is an aliphatic or aromatic hydrocarbon radical having 1 to 14 carbon atoms or COR′ wherein R′ is an aliphatic or aromatic hydrocarbon radical having 1 to 14 carbon atoms; each OR^{e} group is the same or different; X is independently chlorine, bromine or iodine; ED is an electron donor, especially ethylbenzoate; d′ is 1 to 36, preferably 6-18, most preferably 10-14; e′ is 0-3, preferably 0.01-2, most preferably 0.01-1; f′ is 20-40, preferably 25-35, most preferably 27-29; and g′ is 0.1-3, preferably 0.3-2.5, most preferably 0.5-2.

In an optional step according to the invention, the procatalyst may be contacted (exchanged) with an organic chlorinating agent, especially benzoyl chloride, in order to convert residual alkoxide moieties in the solid procatalyst to chloride moieties. Benzoyl chloride is the preferred organic reagent due to the fact that the alkyl benzoate which is formed as a by-product of the chlorination appears to be an effective internal donor, resulting in a more efficient polymerization catalyst. The foregoing procedure may be repeated one time (2 contactings total), and preferably two times (3 contactings total), until a suitable procatalyst composition is attained. Contacting with the organic chlorinating agent in at least two steps is preferred in order to achieve maximum catalyst efficiency. One or more of the previously mentioned halogenating agents, preferably TiCl₄, can be present in combination with the organic chlorinating reagent, and preferably is present during at least the first and second contactings for best results.

The exchange process is desirably conducted at an elevated temperature from 50 to 130° C., preferably from 70 to 120° C., most preferably from 70 to 115° C., over a time period of from 10 minutes to 3 hours, preferably from 30 minutes to 90 minutes, most preferably from 40 to 80 minutes. After each of the foregoing exchanges, the solid, exchanged procatalyst composition is separated from the exchange mixture, desirably by filtration, and may be rinsed with a hydrocarbon, halohydrocarbon or halocarbon solvent, if desired. Such filtration step may occur over a time period from 10 minutes to 2 hours, preferably from 30 minutes to 100 minutes. It is generally preferred that all of the foregoing halogenation and exchange steps, including intervening filtrations or other form of recovery, and optional washings, occur without substantial cooling of the procatalyst composition. By substantial cooling is meant cooling by more than 25° C. Highly desirably, the solid reaction product is retained at a temperature of at least 90° C. until all exchanges and washes are complete.

After the foregoing exchange procedure (if conducted), the resulting solid, exchanged, procatalyst composition is separated from the reaction medium employed in the final process, preferably by filtering, to produce a moist filter cake. The resulting filter cake may again be halogenated one or more times according to the previously disclosed procedure, if desired, or extracted with a solvent to selectively remove procatalyst components. The moist filter cake desirably is then rinsed or washed with a liquid diluent, preferably an aliphatic hydrocarbon, to remove at least a portion of any undesired by-products and unreacted chlorinating agent. Typically the solid, exchanged procatalyst composition is washed one or more times with an aliphatic hydrocarbon such as isopentane, isooctane, isohexane, hexane, pentane, or octane, or a mixture thereof.

The resulting solid procatalyst composition is desirably in the form of porous particles. The resulting composition desirably corresponds to the formula: Mg_{d″}Ti(OR^{e})_{e″}X′_{f″}(ED)_{g″}wherein R^{e}, independently each occurrence, is an aliphatic or aromatic hydrocarbon radical having 1 to 14 carbon atoms or COR′ wherein R′ is an aliphatic or aromatic hydrocarbon radical having 1 to 14 carbon atoms; X′ is chlorine; ED is an electron donor, especially ethylbenzoate or diisobutyl phthalate; d″ is 1 to 36, preferably 6-18, most preferably 10-14; e″ is 0-2, preferably 0-1, most preferably 0-0.5; f″ is 20-40, preferably 25-35, most preferably 27-29; and g″ is 0.1-3, preferably 0.3-2.5, most preferably 0.5-2. Desirably, the residual alkoxide content of the resulting solid procatalyst composition is 5 weight percent or less, more preferably 3 weight percent or less, most preferably 1 weight percent or less.

Any of the foregoing process steps may be repeated one or more times if desired, and the various process steps may be combined or practiced separately or in any order. The foregoing techniques are previously known in the art with respect to different procatalyst compositions.

It is believed, without wishing to be bound by such belief, that further halogenating by contacting the previously formed procatalyst composition with a titanium halide compound, especially a dilute solution thereof in a halohydrocarbon diluent, at the same time as the foregoing exchange process is conducted, results in desirable modification of the procatalyst composition, possibly by removal of certain inactive metal compounds that are soluble in the foregoing diluent. Accordingly, in a highly preferred embodiment of the present invention the exchange process is conducted in the presence of a titanium halide and a halohydrocarbon diluent, especially TiCl₄ and chlorobenzene. Highly desirably, the exchange utilizes a mixture of inorganic halogenating agent/diluent/exchange agent on a molar basis from 1/1-10/0.001-0.1. Most preferably a mixture of TiCl₄/monochlorobenzene/benzoylchloride is used in a molar ratio range from 1/1-10/0.005-0.1. The quantity of the foregoing exchange reagent (organic chlorinating agent) used with respect to the solid procatalyst (based on moles of Ti species in the procatalyst/ moles exchange reagent) is from 1/1 to 1/100, preferably from ½ to 1/10.

Substitution refers to a process by which the procatalyst may be further modified by incorporation of a halide salt compound therein. Suitable halide salt compounds include those compounds that are capable of removing titanium species from the solid procatalyst material or adjusting the type or quantity of titanium species in the procatalyst composition without detrimentally affecting the resulting catalyst properties. It is preferred that the halide salt compound is soluble in the medium that contains the procatalyst or the precursor components and is different than the halogenating agent. The halide salt compound may be employed by itself, or it may be complexed with another compound, such as an internal electron donor.

More than one halide salt compound may be used in the substitution process if desired. Suitable halide salt compounds for the foregoing substitution procedure include: TiCI4, ZrCI4, VCl₄, WCl₆, VOCl₃, SnCl₄, SiCl₄ and mixtures thereof Soluble complexes of such metal halides complexed with the appropriate ligands, such as diisobutyl phthalate (DIBP), also may be used as well. Examples include ZrCl₄(DIBP) and VCl₄(DIBP). If a complex of a metal salt is employed, it is desirable that some quantity of TiCl₄ be included in the substitution mixture. The presence of a small quantity of TiCl₄ in the substitution medium has desirably been found to reduce adverse affects caused by release of electron donor from the procatalyst composition during the substitution. The substitution step may be combined with the previously mentioned exchange procedure, if desired.

In a further preferred embodiment, the solid procatalyst composition is extracted to remove non-active titanium halide species by exposure to a suitable diluent, optionally at elevated temperature. One such process involves contacting the solid procatalyst, optionally additional electron donor, and an halohydrocarbon at an elevated temperature, for example, a temperature of up to 150C, for a period of time following the foregoing exchange. It is particularly preferred to conduct the extraction at a temperature greater than 45° C., preferably greater than 85° C., more preferably greater than 115° C., and most preferably greater than 120° C., to a temperature up to 200° C., more preferably up to 150° C.

Best results are obtained if the materials are contacted initially at ambient temperature and then heated. Sufficient tetravalent titanium halide may be provided to further convert any residual alkoxide moieties of the procatalyst to halide groups at the same time as the extraction. The extraction process is conducted in one or more contacting operations, each of which is conducted over a period of time ranging from a few minutes to a few hours and it is preferred to have a halohydrocarbon present during each contacting.

Suitable extractants include aliphatic, cycloaliphatic, or aromatic hydrocarbons, halogenated derivatives thereof, and mixtures thereof. Exemplary aliphatic hydrocarbons include pentane, and octane. Exemplary cycloaliphatic hydrocarbons include cyclopentane, cyclohexane, and cyclooctane. Exemplary aromatic hydrocarbons include benzene, alkylbenzenes, and dialkylbenzenes. Exemplary halogenated derivatives of the foregoing include methylenechloride, methylenebromide, chloroform, carbon tetrachloride, 1,2-dibromoethane, 1,1,2-trichloroethane, trichlorocyclohexane, dichlorofluoromethane, tetrachlorooctane, chlorinated benzenes, bromobenzene, dichlorobenzene, and chlorinated toluenes. Particularly preferred aliphatic hydrocarbons include pentane, isopentane, octane, and isooctane. Particularly preferred aromatic hydrocarbons include benzene, toluene, and xylene. Particularly preferred halohydrocarbons include carbon tetrachloride, 1,1,2-trichloroethane, chlorinated benzenes and chlorinated toluenes. Most highly preferred extractants are aromatic hydrocarbons and halohydrocarbons, especially toluene, xylene, ethylbenzene, chlorobenzene, chlorotoluene and dichlorobenzene. Desirably the extractant selected has a boiling point above the temperature used in the extraction so as to avoid the use of high pressure equipment.

The amount of extractant employed can be any effective amount capable of removing titanium species from the solid procatalyst. It is preferred that the extractant be used in an amount ranging from 0.1 to 1000 milliliters per gram of solid procatalyst material. More preferably, the amount of extractant used ranges from 1 to 500 mL/g of solid procatalyst, and most preferably from 5 to 50 mL/g of solid procatalyst.

The amount of time the solid procatalyst material and the extractant are contacted is not critical so long as it is sufficient to remove undesired, soluble titanium species from the solid procatalyst material. There is no upper limit on the duration of contact from an efficacy standpoint, but economics typically play a role on the length of time the components will be contacted with one another. Preferably, the components are contacted from 2 minutes to 12 hours, more preferably from 5 minutes to 4 hours, and most preferably, from 15 minutes to 2 hours. Longer contact times and/or repeated extractions may be required if lower extraction temperatures or less efficient extractants are employed. The extraction may be conducted at any suitable pressure, but preferably atmospheric pressure or elevated pressures are employed.

Typically unextracted, solid procatalysts have a titanium content anywhere from 2.5 percent to 6 percent, as determined by plasma emission spectroscopy. In contrast, an extracted procatalyst has from 5 up to 80 percent less titanium content, more preferably from 7 up to 75 percent less titanium, and most preferably, anywhere from 10 to 70 percent less titanium content than a similarly prepared but unextracted composition. The extraction may be repeated any number of times with the same or varied reagents, concentrations of reagents, temperatures of reaction and time of reaction in order to achieve the desired titanium content of the solid procatalyst.

After preparation of the procatalyst, the resulting product is washed or rinsed with the rinse diluent, preferably an inert hydrocarbon, especially an aliphatic liquid hydrocarbon, preferably a compound that is different than the extractant, to remove at least a portion of residual reagents and by-products from the solid procatalyst. The resulting procatalyst composition is then separated, normally by use of a filter, such as a multiple leaf filter, and dried to the extent previously disclosed. Preferably, the content of extractant, rinse diluent, or both, present in the solid composition prior to drying, is at least 25 percent, more preferably at least 27 percent.

Drying is occasioned by venting the filter vessel containing the washed solid procatalyst, optionally passing an inert gas, preferably nitrogen, over the solid procatalyst, and optionally heating the solid procatalyst until the desired quantity of rinse diluent is removed. Desirably the drying gas is relatively cool compared to the temperature of the separated procatalyst at this stage of the preparation. Suitable inlet temperatures for the drying gas are from 0 to 50° C., preferably from 5 to 40° C. By using a relatively cool drying gas within the foregoing ranges and stopping the process when 7-25 percent, preferably 10-20 percent, more preferably 12-18 percent of the rinse diluent, especially isopentane, remains in the product, the formation of relatively large sized procatalyst particles has been found to be greatly reduced. Typical drying times employed are from 1 to 60 minutes.

As a final step in the present process, the solid, partially dried procatalyst is contacted with the hydrocarbon oil to form a dispersion or slurry. The partially dried procatalyst compositions, especially those wherein the wash diluent employed is a saturated, aliphatic hydrocarbon, especially isopentane, readily disperse in the hydrocarbon oil used to form the dispersion with minimal stirring or agitation. Additionally, the relative lack of large particle formation during the drying step, as previously mentioned, results in improved particle morphology, especially a reduction of large catalyst particles. Desirably, the resulting mineral oil dispersed solid procatalyst gives less than 5.0 percent retained large particles (on a dry weight basis), preferably less than 2.0 percent, when filtered through a 35 mesh (0.5×0.5 mm opening size) screen.

The solid, exchanged procatalyst composition serves as one component of a Ziegler-Natta catalyst composition, in combination with a cocatalyst and a selectivity control agent. The cocatalyst component employed in the Ziegler-Natta catalyst system may be chosen from any of the known activators of olefin polymerization catalyst systems employing a titanium halide, especially organoaluminum compounds. Examples include trialkylaluminum compounds and alkylaluminum halide compounds in which each alkyl group independently has from 1 to 6 carbon atoms. The preferred organoaluminum cocatalysts are triethylaluminum, triisopropylaluminum, and triisobutylaluminum. The cocatalyst is preferably employed in a molar ratio of aluminum to titanium of the procatalyst of from 1:1 to 500:1, but more preferably in a molar ratio of from 10:1 to 200:1.

The final component of a stereoselective, Ziegler-Natta catalyst composition is the selectivity control agent (SCA), or external electron donor. Typical SCAs are those conventionally employed in conjunction with titanium-based Ziegler-Natta catalysts. Illustrative of suitable selectivity control agents are those classes of electron donors employed in procatalyst production as described above, as well as organosilane or polyorganosilane compounds containing at least one silicon-oxygen-carbon linkage. Suitable silicon compounds include those of the formula, R¹ₘSiYₙX″ₚ, or oligomeric or polymeric derivatives thereof, wherein: R¹ is a hydrocarbon radical containing from 3 to 20 carbon atoms, Y is —OR² or —OCOR² wherein R² is a hydrocarbon radical or a hydrocarbyloxy-substituted derivative thereof containing from 1 to 20 carbon atoms, X″ is hydrogen or halogen, m is an integer having a value of from 0 to 3, n is an integer having a value of from 1 to 4, p is an integer having a value of from 0 to 1, and preferably 0, and m+n+p=4. Highly preferably, R¹ in at least one occurrence is not a primary alkyl group, and the non-primary carbon thereof is attached directly to the silicon atom. Examples of R¹ include n-propyl, isopropyl, n-butyl, isobutyl, t-butyl, cyclopentyl, and cyclohexyl. Examples of R² include methyl, ethyl, butyl, isopropyl, phenyl, benzyl, methoxyethyl, and 2-methoxypropyl. Examples of X″ are Cl and H. Each R¹ and R² may be the same or different, and, if a polyatomic radical, substituted with any substituent which is inert under the reaction conditions employed during polymerization. Preferably, R² is an aliphatic or cycloaliphatic group, containing from 1 to 10 carbon atoms or a C₆₋₁₀ aromatic group. Silicon compounds in which two or more silicon atoms are linked to each other by an oxygen atom, such as, siloxanes or polysiloxanes, may also be employed, provided the requisite silicon-oxygen-carbon linkage is also present.

The preferred selectivity control agents are alkyl esters of ring alkoxy-substituted aromatic carboxylic acids or dicarboxylic acids, especially ethyl p-methoxybenzoate or ethyl p-ethoxybenzoate (PEEB), or siloxane compounds, such as n-propyltrimethoxysilane, cyclohexylmethyldimethoxysilane, or dicyclopentyldimethoxysilane. In one embodiment of the invention, the foregoing selectivity control agent may form at least a portion of the electron donor added during procatalyst production. In an alternate modification, the selectivity control agent is added only after formation of the procatalyst and may be added to a catalyst forming mixture or to an olefin polymerization mixture simultaneously or non-simultaneously with addition of the cocatalyst.

The selectivity control agent preferably is provided in a quantity of from 0.01 mole to 100 moles per mole of titanium in the procatalyst. Preferred quantities of selectivity control agent are from 0.5 mole to 50 mole per mole of titanium in the procatalyst.

The olefin polymerization catalyst is produced by any suitable procedure of contacting the solid procatalyst, the cocatalyst, and optional selectivity control agent. The method of contacting is not critical. The catalyst components or combinations thereof can be precontacted prior to polymerization to form a preactivated catalyst, or the components can be contacted at the same or nearly the same time as contact is made with the olefin monomer. In one modification, the catalyst components simply are mixed in a suitable vessel and the preformed catalyst thereby produced is introduced into the polymerization reactor when initiation of polymerization is desired. In an alternate modification, the catalyst components are separately introduced into the polymerization reactor, or the cocatalyst and SCA are premixed with monomer and the procatalyst added separately, thereby forming the active catalyst species in situ. In a final embodiment, the catalyst components may be introduced into one polymerization reactor and prepolymerized with one or more olefm monomers and subsequently contacted with additional olefin monomers, which may be the same or different from the olefin monomers used in the prepolymerization. The subsequent polymerization may take place in the same or in a different polymerization reactor and may include separate addition of one or more of the catalyst components during said subsequent polymerization.

The olefm polymerization catalyst may be used in slurry, liquid phase, gas phase or bulk, liquid monomer-type polymerization processes as are known in the art for polymerizing olefins, or in a combination of such processes. Polymerization preferably is conducted in a fluidized bed polymerization reactor by continuously contacting an alpha-olefm having 3 to 8 carbon atoms with the three components of the catalyst system, that is, the solid procatalyst component, cocatalyst, and SCA or mixture of SCAs. In accordance with the process, discrete portions of the catalyst components are continuously or semi-cntinuously fed to the reactor in catalytically effective amounts together with the alpha-olefin and any additional components, while the polymer product is continuously or semi-continuously removed therefrom. Fluidized bed reactors suitable for continuously polymerizing alpha-olefms have been previously described and are well known in the art. Suitable fluidized bed reactors useful for this purpose are described in U.S. Pat. Nos. 4,302,565, 4,302,566, 4,303,771, and elsewhere.

It is sometimes preferred that a fluidized bed be operated using a recycle stream of unreacted monomer wherein at least a portion of the recycle stream is condensed. A relatively low boiling, condensing agent may be included in the reaction mixture as well. The foregoing procedures are referred to as “condensing mode” and “super condensing mode”. Operating a fluidized bed reactor in such manner generally is known in the art and described in, U.S. Pat. Nos. 4,543,399 and 4,588,790, and elsewhere. The use of condensing mode or super condensing mode has been found to be especially useftil to increase catalyst activity, lower the amount of xylene solubles in isotactic polypropylene, and to improve overall catalyst performance when using catalysts prepared according to the present invention.

The precise procedures and conditions of the polymerization are broadly conventional but the olefin polymerization process, by virtue of the use therein of the polymerization catalyst formed from a dispersed, solid procatalyst of the invention, provides a polyolefin product and particularly a polypropylene product having a relatively high bulk density in quantities that reflect the relatively high productivity of the olefin polymerization catalyst. Desirably, the bulk density of the resulting polymer (pbd) as determined by gravimetric analysis is at least 0.33 g/cm³, more preferably at least 0.35 g/cm³. Increase in bulk density allows higher reactor capacity utilization or efficiency of operation, and accordingly is highly desired.

The xylene solubles content of the polypropylene products of the invention preferably are less than 5 percent, more preferably from 1.0 to 4.5 percent. In addition, the polyolefin product preferably will contain reduced amounts of catalyst residue. Preferably, the polymer will have a titanium content (a measure of catalyst residue and hence of catalyst efficiency) of less than 1×10⁻³ weight percent, more preferably less than 1×10⁻⁴ weight percent, most preferably less than 5×10⁻⁵ weight percent.

The polymerization product of the present invention can be any product, including homopolymers or copolymers. Usually, the polymerization product is a homopolymer of polypropylene. Alternatively the procatalyst dispersion and process of the invention are useful in the production of copolymers of ethylene and propylene such as EPR and polypropylene impact copolymers, such as EPR modified polypropylene, when two or more olefin monomers are supplied to the polymerization process. The catalyst compositions may be used to prepare polymers using solution, slurry, or gas phase reaction conditions previously known in the art.

It is expressly intended that the foregoing disclosure of preferred or desired, more preferred or more desired, highly preferred or highly desired, or most preferred or most desired substituents, ranges, end uses, processes, or combinations with respect to any one of the embodiments of the invention is applicable as well to any other of the preceding or succeeding embodiments of the invention, independently of the identity of any other specific substituent, range, use, process, or combination.

The invention is further illustrated by the following examples that should not be regarded as limiting the same. Unless stated to the contrary, implicit from the context, or conventional in the art, all parts and percentages recited herein are based on weight. The quantity of oversize particles is determined using a wet sieving method. Accordingly, a known amount of the procatalyst/ mineral oil slurry is placed in a filter flask equipped with a 35 mesh (0.5 mm×0.5 mm) screen and washed through the screen using copious amounts of isooctane.

Solids remaining on the screen are dried in flowing nitrogen and weighed.

### EXAMPLE 1

A titanium containing Ziegler-Natta procatalyst precursor composition is prepared by slurrying a mixture of a magnesium and titanium containing precursor corresponding to the formula Mg₃Ti(OC₂H₅)₈Cl₂ (made substantially according to U.S. Pat. No. 5,077,357) and diisobutylphthalate (0.3 liter/kilogram precursor) in a 50/50 (vol/vol) mixture of TiCl₄/monochlorobenzene (MCB), in the amount of 19 liters/kilogram precursor. The mixture is heated at 110° C. for 60 minutes and filtered. The resulting moist mass is slurried in a 50/50 TiCl₄/MCB mixture (19 liters/kilogram precursor) and again heated to 110° C. for 30 minutes, filtered, and the process repeated once more. The resulting solid is rinsed with isopentane, filtered and then dried with flowing cool nitrogen (less than 32° C.) for one hour. The resulting procatalyst contains a residual isopentane content of 15 percent. A 30 percent slurry in mineral oil is readily prepared by adding the appropriate quantity to a stirred glass flask containing mineral oil. Subsequent filtration of the mineral oil slurry through a 35 mesh (0.5 mm×0.5 mm opening size) screen results in a retained oversized particle content of 0.8 percent on a dry solids basis.

The resulting exchanged procatalyst compositions are tested for olefin polymerization activity by charging 0.70 mmoles of triethylalurninum cocatalyst, 0.35 mmoles ethyl p-ethoxybenzoate SCA, and 16.2 mg of the procatalyst composition as a slurry in mineral oil into an autoclave reactor containing 1375 grams of liquid propylene and 13 mmole H₂ for one hour at 67° C. No temperature excursions or other process difficulties are encountered. After venting and cooling of the polymerization reactor, the product is collected, dried in air, and weighed. The resulting isotactic polypropylene product is determined to be suitable for use in the manufacture of molded articles, protective films and fibers.

Comparative A

The same process conditions employed in Example 1 are repeated excepting that the recovered filter cake after rinsing with isopentane is dried in a stream of heated (46° C.) dry nitrogen for 90 minutes. The resulting procatalyst composition has a residual isooctane content of 5 percent. A 30 percent slurry in mineral oil is filtered through a 35 mesh (0.5 mm×0.5 mm opening size) screen. The retained particles constitute 11.9 percent on a dry solids basis.

1. A method of making a hydrocarbon oil dispersion of a solid procatalyst composition for use in a Ziegler-Natta olefin polymerization catalyst composition, said method comprising:
contacting a solid precursor composition comprising magnesium, titanium, and alkoxide moieties with a halogenating agent and an internal electron donor in any order, in a suitable reaction medium to prepare a solid procatalyst composition by halogen exchange;
separating the solid procatalyst composition from the reaction medium;
optionally further halogenating the solid procatalyst composition, exchanging the procatalyst composition under metathesis conditions, substituting metal values in the procatalyst composition, and/or extracting the procatalyst composition;
rinsing the procatalyst composition with liquid rinse diluent to remove at least a portion of by-products and/or unreacted halogenating agent;
separating the procatalyst composition from the liquid rinse diluent to provide a solid mass containing residual liquid rinse diluent;
partially drying the solid procatalyst composition to provide a mass having a residual liquid rinse diluent content of from 7 to 25 percent; and
dispersing the partially dried, solid precursor composition in a hydrocarbon oil.

2. The method of claim 1 wherein the internal electron donor is a C₁₋₄ alkyl ester of an aromatic monocarboxylic or dicarboxylic acid, or a C₁₋₄ alkyl ether derivative thereof.

3. The method of claim 2 wherein the internal electron donor is ethylbenzoate, ethyl p-ethoxybenzoate, di-n-butylphthalate, or diisobutylphthalate.

4. The method of claim 1 wherein the rinse diluent is an aliphatic hydrocarbon.

5. The method of claim 1 wherein the rinse diluent is partially removed under flowing nitrogen at an initial inlet temperature from 0 to 50° C. for a time from 1 to 60 minutes.

6. The method of claim 1 wherein the retained, oversized solids upon sieving the hydrocarbon dispersion through a 35 mesh (0.5 mm×0.5 mm opening size) screen is 5.0 percent or less on a dry solids basis.

7. The method of claim 1 wherein the amount of residual liquid rinse diluent in the partially dried procatalyst that is dispersed in the hydrocarbon oil is from 10 to 20 percent.
